(19) United States
(12) Patent Application Publication
(10) Pub. No.: US 2013/0125525 A1
(43) Pub. Date: May 23, 2013

(54) GAS TURBINE POWER PLANT WITH A GAS TURBINE INSTALLATION, AND METHOD FOR OPERATING A GAS TURBINE POWER PLANT

(71) Applicants: Olaf Hein, Mulheim an der Ruhr (DE); Hardy Kliemke, Brieselang (DE); Andreas Waruschewski, Essen (DE)

(72) Inventors: Olaf Hein, Mulheim an der Ruhr (DE); Hardy Kliemke, Brieselang (DE); Andreas Waruschewski, Essen (DE)

(21) Appl. No.: 13/670,684

(22) Filed: Nov. 7, 2012

(30) Foreign Application Priority Data
Nov. 17, 2011 (EP) 11189545.4

(51) Int. Cl. F01K 23/10; F01K 3/02; F02C 6/04; F01K 13/00

(52) U.S. Cl. CPC F01K 23/10; F01K 13/00; F01K 3/02; F02C 6/04
USPC 60/39.182; 60/39.15; 60/39.511; 60/659; 60/772

(57) ABSTRACT

A gas turbine power plant and a method for operating a gas turbine power plant are provided. The power plant includes a gas turbine installation which may supply a mains supply network with electric power and includes a compressor and an associated first gas turbine. Differing from previous gas turbine installations, the compressor of the gas turbine installation and the first gas turbine of the gas turbine installation are decoupled from each other. A second turbine is provided which drives compressor. As a result, the compressor of the gas turbine installation is operated independently of the first gas turbine. Influences on the mains supply network side, such as generating deficiencies in the main supply network, which act upon the first gas turbine as a result of speed reduction, are also not able to have an impact upon the compressor which is decoupled from the first gas turbine.

### CROSS REFERENCE TO RELATED APPLICATIONS

This application claims priority of European Patent Office application No. 11189545.4 EP filed Nov. 17, 2011. All of the applications are incorporated by reference herein in their entirety.

### FIELD OF INVENTION

A gas turbine power plant with a gas turbine installation, and also to a method for operating a gas turbine power plant is provided.

### BACKGROUND OF INVENTION

Gas turbine power plants with gas turbine installations are widely known.

A gas turbine power plant is a power plant with a gas turbine installation consisting of a compressor, a combustion chamber with in most cases a plurality of burners, and a gas turbine for power generation.

A gas turbine power plant is operated with fluid fuels. As a rule, these fuels are hydrocarbons, alcohols, coal-derived gas, or natural gas. These fluids are the fuel for the gas turbine installation, the gas turbine of which drives a generator, which is coupled to it, for power generation.

In this case, the compressor, which is also mechanically coupled to the gas turbine and driven by this, first of all inducts fresh air for the combustion process and compresses this to values which mostly lie within the range of 15 bar-20 bar.

The compressed air is fed with the fuel into the combustion chamber. The mixture of fresh air and fuel is ignited there, by means of the burner, or the burners, in order to then combust the mixture there, wherein combustion gases, essentially carbon dioxide, water vapor, nitrogen and oxygen, reach temperatures of up to about 1500° C. and above.

The hot exhaust gases then flow into the gas turbine in which these yield some of their energy as kinetic energy to the gas turbine as a result of expansion.

By means of the generator which is coupled to the gas turbine, the mechanical energy is then converted into electric energy which is fed as electric current into a mains supply network.

Exhaust gases or flue gases (enriched with carbon dioxide) are discharged from the gas turbine exhaust either directly or sometimes even via a heat exchanger.

Other categories of power plants, for example steam power plants, are also known.

A steam power plant, similar to the gas turbine power plant, is a type of power plant for generating power from usually solid fuels, in which the chemical energy of the fuel is converted into thermal energy of steam. This in turn is converted into kinetic energy in a steam turbine so that this kinetic energy is then further converted into electric energy in a generator.

Depending upon the fuel or operating medium, a distinction is made between different types of steam power plant, such as coal-fired power plants, oil-fired power plants, or gas and steam combined cycle power plants (CCPP).

A coal-fired power plant is a special form of steam turbine power plant, in which coal is used as primary fuel for producing steam. Such coal-fired power plants for brown coal as well as for hard coal are known.

In a deregulated energy market which is established on an energy mix of different types of especially decentralized energy producers, a flexible load operation of power plants with capability for (fast) load/power control and/or frequency control in mains supply networks and also a storage capability of (surplus) power in the mains supply networks (“smart grid”), are increasingly gaining in importance.

With regard to frequency control in mains supply networks, a distinction is made between different types of frequency control, for example primary control and secondary control.

Since electric energy cannot be stored, or stored only with difficulty, en route from the producer to the consumer, power generation and power consumption must be in equilibrium in the mains supply network at any moment, i.e. exactly the same amount of electric energy has to be produced as is consumed.

The frequency of the electric energy is in this case an integrating control variable and assumes a network frequency nominal value, as long as power generation and power consumption are in equilibrium. Rotational speeds of the power plant generators which are connected to a mains supply network are synchronized with this network frequency.

If, at a specific point in time, an energy deficiency occurs in the mains supply network, then this deficiency is first of all met by an energy contained in centrifugal masses of rotating machines, i.e. turbines, generators and compressors. The machines, or the components which rotate on account of their rigid intercoupling or mutual coupling, especially the compressor, turbine and generator, are consequently braked, as a result of which their rotational speed and therefore the (network) frequency drop further.

Such an occurrent frequency change therefore has an effect upon the entire turbine installation, such as upon the compressor, gas turbine and generator in the case of a gas turbine installation.

If this drop of the network frequency is not counteracted by means of suitable power control or frequency control in the mains supply network, this could lead to system collapse.

Therefore, frequency deviations within the range of 0.1-3.0 Hz, brought about, for example, by power plant failures and fluctuations in current consumption, are distributed by the primary control to the power plants within the entire mains supply network which participate in the primary control. For this, these therefore provide a so-called primary control reserve, that is to say a power reserve, which is delivered automatically from the participating power plants to the mains supply network in order to consequently compensate within seconds the imbalance between production and consumption by controlling the production.

The primary control therefore serves for stabilization of the network frequency in the event of the smallest possible deviation, but at a level which deviates from a predetermined network frequency nominal value.

The secondary control which is connected to the primary control has the task of re-establishing the equilibrium between the electricity producers and electricity consumers in the mains supply network and, as a result, to return the network frequency again to the predetermined network frequency nominal value, e.g. 50 Hz, and to re-establish the equilibrium between the electricity producers and electricity consumers in the main supply network.

The power plants which participate in secondary control provide a secondary control reserve for this in order to return the network frequency again to the network frequency nominal value and to re-establish the equilibrium in the mains supply network.

In part, the provision of frequency control reserve or secondary and/or primary control reserve for the power plants is mandatory to a certain extent as a result of national regulations. Control reserves which are provided by the power plants are as a rule paid back to the power plants as special network services.

Even for large modern thermal power plants with supercritical steam generators, which usually run in base load mode, participation—if not mandatory anyway—in frequency control or non-base load mode can be economically attractive.

Also, with the development of regenerative energy (wind energy) combined with its fluctuating electricity production, a tightening of requirements for a controllability even of large power plant units and also a storage capability of surplus quantities of renewable energy in the network—resulting from the fluctuating electricity production—are anticipated or desirable.

### SUMMARY OF INVENTION

An object is to provide a gas turbine power plant and also a method for operating a gas turbine power plant, which makes it possible to meet the requirements for future mains supply networks with decentralized, different electricity producers and their fluctuating electricity production there, especially with stipulated flexible load operation there.

Another object is to enable gas turbine power plants to run fast power gradients which are required on the mains supply network side.

A further object is to provide a gas turbine power plant and also a method for operating a gas turbine power plant, which ensure an ecological and environmentally friendly operation of a gas turbine power plant and also an ecological and environmentally friendly power generation and such a network operation in general.

The object is achieved by means of a gas turbine power plant and also by means of a method for operating a gas turbine power plant according to the respective independent claim.

The gas turbine power plant has a gas turbine installation with at least one compressor and an associated first gas turbine.

This gas turbine installation is provided for making available electric power for a mains supply network or for generating electric power which is to be fed into the mains supply network.

In this case, it is to be understood by gas turbine installation with associated compressor and associated first gas turbine that the compressor and the first gas turbine, at least in this respect, form a plant engineering unit, that is to say the gas turbine installation, and that the first gas turbine is operated (fluidic connection) with compressed gas or air of the compressor (generally with compressed operating medium of the compressor).

Deviating from such previous gas turbine installations, in which the compressor and the gas turbine, moreover, are rigidly mechanically coupled via a shaft, i.e. over and above the fluidic connection, it is provided that the compressor of the gas turbine installation and the first gas turbine of this gas turbine installation are decoupled from each other with regard to this (mechanical) coupling.

In this case, it may be understood by decoupled that the compressor can then be driven completely independently of the first gas turbine. In short, compressor section and turbine section of the gas turbine installation are mechanically decoupled.

The decoupling of the compressor from the first gas turbine especially ensures that this compressor can be run independently of a rotational speed of the first gas turbine, that is to say at other rotational speeds which are independent of the turbine rotational speeds of the first gas turbine.

Influences on the mains supply network side, such as generating deficiencies in the mains supply network, which as a result of rotational speed reduction act upon the first gas turbine, are consequently not able to have an impact upon the compressor which is decoupled from the first gas turbine.

A provision is then made for a second turbine, especially a second gas turbine or a steam turbine, by use of which the compressor can be driven.

This drive can especially be realized by an output shaft of this second turbine, especially of this gas turbine, being connected—possibly by means of a coupling and/or a gearbox connected in between—to a drive shaft of the compressor (direct coupling or direct drive, that is to say output-input shaft coupling).

It can also be provided that by means of a generator, which is connected to the second turbine or second gas turbine and driven by this, electric power is generated and used for an electric drive of the compressor, which for example is provided in the form of an electric motor in the compressor (indirect drive).

Expressed clearly and simply, the gas turbine power plant provides the mechanical decoupling of compressor and first gas turbine in a gas turbine installation which is provided for supplying electricity to a mains supply network, deviating from such conventional gas turbine installations, and realizes the drive of the compressor of this gas turbine installation by means of a second, independent turbine, especially a gas or steam turbine, directly or indirectly, for example via an electric motor.

Consequently, the compressor becomes independent of the first gas turbine and therefore independent of its rotational speed as well as independent of load-induced network frequency change in the mains supply network.

Influences on the mains supply network side, such as generating deficiencies in the mains supply network, which act upon the first gas turbine as a result of rotational speed reduction, are consequently not able to have an impact either upon the compressor which is decoupled from the first gas turbine.

This gives the gas turbine power plant the capability to react flexibly and also rapidly to fluctuations in the mains supply network, for example by increasing the compressor rotational speed or compressor output.

Also, as a result of the decoupling of the compressor section and the turbine section in the gas turbine installation, fuel consumption of the first gas turbine—especially if the gas turbine power plant with the gas turbine installation, i.e. especially the first gas turbine and/or the second turbine is, or are, held in operational readiness in a standby mode (without power output to a mains supply network)—can be reduced, for example at times when a power requirement in the mains supply network is met principally from renewable energy.

In the standby mode, in which the gas turbine power plant or the gas turbine installation/first gas turbine is then decoupled from the mains supply network, i.e. no feed of electric power to the mains supply network takes place in this case, the first gas turbine can preferably be run, without load, at rotational speeds within the range of 0% up to a rated rotational speed maximum.

Since the first gas turbine is decoupled from the compressor, in this case only the friction losses of (shaft) bearings and/or ventilation losses, especially in the generator which is connected to the first gas turbine, are to be overcome and ultimately requires only a fraction of the fuel quantity which otherwise is about 20%-30% of the base load quantity in the case of coupled compressor-turbine plants.

If the first gas turbine is, or becomes, additionally also decoupled from the generator, for example when using a clutch, then the fuel consumption drops still further in standby mode.

If the gas turbine installation with the first gas turbine and also the second turbine are held in standby mode at approximately operating temperature, then this ensures that the gas turbine(s) can furthermore still implement a rapid power increase if the maximum possible power is to be delivered.

An air supply of the gas turbine installation and of the first gas turbine for this standby mode, especially for maintaining the operating temperature in the first gas turbine, can be realized by means of a blower, which is coupled to the first gas turbine, and also by means of a heat source, for example a burner or furnace, which heats especially the blower air.

In this case, (blower) air can then be blown through pilot burners of the gas turbine installation, where this air, with fuel, can be heated to about 600° C. to 700° C., for example. This hot air—if necessary with a continuous separation of some of the exhaust gases and addition of fresh air blown in via the blower—circulates in the gas turbine installation and holds components or component parts of the gas turbine installation or of the first gas turbine at temperature.

In an alternative of maintaining operating temperature, the exhaust gases can be extracted not only in part but also completely (no circulation). If these exhaust gases yield heat to the blower air, by means of a heat exchanger, then hot blower air is constantly made available for the hot air flow through the first gas turbine installation.

As a further alternative for maintaining operating temperature in standby mode, it can also be provided to realize a separate air circulation with separate circulating air delivered by the blower, which then operates independently of the burner air. To this end, use is made of oil or gas operated furnaces, for example, which heat the blower air to a correspondingly high level.

As a result, i.e. because all the components, especially the first gas turbine, are at operating temperature, it is possible to bring the gas turbine installation very rapidly up to high power if high outputs are required within a short time, for example in the event of a drop in renewable energy in the mains supply network for weather-related reasons.

According to the provided method for operating a gas turbine power plant with a gas turbine installation which has at least one compressor and a first gas turbine, and also with a second turbine, especially a second gas turbine or steam turbine, wherein the compressor of the gas turbine installation and the first gas turbine of the gas turbine installation are decoupled from each other, the compressor of the gas turbine installation is driven by using the second turbine, especially the second gas turbine or steam turbine.

The gas turbine power plant is especially suitable for implementing the method or one of its subsequently explained developments, and also the method for operating the gas turbine power plant is especially suitable for being implemented on the gas turbine power plant or on one of its subsequently explained developments.

Preferred developments are also gathered from the dependent claims and/or from subsequent explanations. The described developments relate both to the gas turbine power plant and to the method for operating a gas turbine power plant. The advantages which are achieved by the gas turbine power plant relate equally to the method for operating a gas turbine power plant, as also vice versa.

In an embodiment, the decoupling of compressor and first gas turbine is realized in such a way that an output shaft of the first gas turbine is decoupled from a drive shaft of the compressor, i.e. (mechanically) separated. For driving the compressor, it can then be additionally provided that an output shaft of the second turbine or of the second gas turbine or steam turbine is coupled to the drive shaft of the compressor, for example by using a clutch and/or a gearbox.

According to a further embodiment, it can be provided that the first gas turbine is coupled to a blower. With this blower, and with a heat source in addition, the first gas turbine can be supplied with heated air, especially in a standby mode of the first gas turbine. As a result, the first gas turbine can be held at operating temperature, or slightly below it, in the standby mode.

Furthermore, it can be provided that the gas turbine installation has a generator which is coupled to the first gas turbine via a clutch. By means of this generator, electricity which is generated by the gas turbine installation or by the gas turbine power plant is fed into a mains supply network.

According to a further embodiment, it is provided that the compressor has a plurality of, for example two or three, compressor sections, then often referred to as a compressor station, which can be driven by using the second turbine, especially the second gas turbine or steam turbine. In particular, it can be provided that the compressor or the compressor station or a compressor unit has two compressor sections, or a plurality of compressor sections, especially with an intercooler, or a plurality of intercoolers.

Waste heat from the compressor intercooling can be re-utilized in this case in a variety of ways in an energetically efficient manner. Thus, a carbon dioxide separation plant, for example, can be operated with the waste heat. Also possible is utilization within the scope of district heating, for a seawater desalination (plant), for brown coal drying in gasification processes or for operating a refrigerating machine for cooling the compressor intake air.

It can also be provided that the first gas turbine is of double-flow design, i.e.

constructed with two turbine sections. In this case, it can be further provided that the generator which is driven by the gas turbine installation is arranged between the two turbine sections. As a result, the drive shafts of the generator can then be installed on the respective, so-called cold side of the turbine sections, that is to say not through exhaust gas passages of the turbine sections. Consequently, thrust forces, which otherwise would have to be absorbed via expensive thrust bearings, can be compensated.

It can also be provided that the gas turbine installation has a first combustion chamber connected to the first gas turbine and supplied with compressor air/gas, with a first burner, or a plurality of first burners, especially a natural gas burner, a coal-derived-gas burner, a diesel oil burner and/or a methanol burner.

In addition, provision can be made for a second combustion chamber—with a burner, or a plurality of burners, especially a natural gas burner—which is connected to the second turbine, especially to the second gas turbine or steam turbine, wherein gas which is compressed by the compressor can also be fed into the second combustion chamber.

According to a further embodiment, provision can be made for an additional, especially electric, drive unit, for example an E-motor, by use of which the compressor can be driven. Additional drive units, in any combination, for example a third gas turbine and/or an additional steam turbine, can also be provided for the compressor.

In another embodiment, provision is made for a recuperator which is arranged between the compressor of the gas turbine installation and the first gas turbine of the gas turbine installation. As a result, gas which is compressed by the compressor flows through the recuperator on one side.

Furthermore, exhaust gas from the first gas turbine and/or from the second turbine, especially from the second gas turbine, can be directed through the recuperator for exchange of heat with the compressor gas. The compressed gas from the compressor is consequently heated, for example to about 600° C.-800° C., wherein the exhaust gas from the first gas turbine and/or from the second turbine gives off some of its heat.

In addition, the residual heat of the exhaust gas, as well as the exhaust gas directly from the first and/or second turbine, i.e. without exchange of heat in the recuperator, can be re-utilized in a variety of ways in an energy-efficient manner.

In this way, a carbon dioxide separation plant, for example, can be operated with the exhaust gas, possibly with additional waste heat from the recuperator. Also possible is utilization within the scope of district heating, for a seawater desalination (plant), for brown coal drying in gasification processes, or for operating a refrigerating machine for cooling the compressor intake air.

Furthermore, provision can be made for a saturation device, by use of which the gas compressed by the compressor of the gas turbine installation, especially upstream of the exchange of heat in the recuperator, can be saturated with water.

This water can be for example mains water, water from a carbon dioxide separation plant or other demineralized water. This saturation device can also be integrated into the recuperator.

According to an embodiment, provision is made for a steam turbine installation—with at least one steam boiler and a steam turbine—especially a liquid fuel-fired or coal-fired, gas-fired or diesel oil-fired steam turbine installation, which is coupled to the first gas turbine. In this case, exhaust gas from the first gas turbine is fed, at least partially, into the steam boiler.

It can also be provided that the steam turbine installation, especially in standby mode of the first gas turbine, is used for driving the compressor. This can be carried out directly, wherein in this case an output shaft of the steam turbine drives the compressor, or can be carried out indirectly, wherein in this case a generator is driven by means of the steam turbine installation and supplies an electric drive unit, such as an E-motor, of the compressor with electric power.

In particular, it is provided in this case that the steam turbine installation is run continuously as far as possible, and not depending upon requirement like the first gas turbine and/or the second turbine, for example. The second gas turbine is especially to be held in readiness in case of need (“standby mode”).

According to a further embodiment, provision is made for a compressed-air storage vessel which is connected downstream to the compressor and upstream to the first gas turbine. That is to say, the compressed-air storage vessel can be filled with a gas which is compressed by the compressor, the compressed gas can be stored there as compressed air, and/or the stored compressed air can be fed from the compressed-air storage vessel to the first gas turbine of the gas turbine installation or to the combustion chamber of this installation, especially for a rapid power increase in the first gas turbine.

If the compressed-air storage vessel is not operated at constant pressure, but at increased pressure, a pressure reduction is required, downstream of the compressed-air storage vessel or upstream of the combustion chamber. This can be realized by means of a throttling element or even an expansion turbine.

It can also be provided that when the compressed-air storage vessel has been discharged this is to be replenished with carbon dioxide. This carbon dioxide can in this case be fed into the compressed-air storage vessel via a carbon dioxide system. Since the carbon dioxide in the carbon dioxide system is provided at higher pressures than in the compressed-air storage vessel, the carbon dioxide which is to be replenished must be expanded to the pressure level of the compressed-air storage vessel, wherein the carbon dioxide which is to be replenished is cooled.

This cooled-down carbon dioxide or its coldness can additionally be utilized to cool down a water flow in a condenser of the gas turbine power plant to such an extent that a condenser pressure can be lowered still further.

It can also be provided that the steam turbine installation or the steam turbine, in a standby phase of the first gas turbine and/or of the second turbine, especially the second gas turbine, delivers the power for filling the compressed-air storage vessel,

In other words, the steam turbine installation, directly or indirectly, drives the compressor which delivers the compressed operating. medium, for example compressor air compressed to 112 bar 30 bar, for filling the compressed-air storage vessel. In this case, the steam turbine installation is then fired with coal, gas, diesel oil or other liquid fuels.

At the same time, carbon dioxide from the compressed-air storage vessel can be extracted and further compressed, for example compressed to 80 bar 120 bar, and then fed into a carbon dioxide system.

Provision can also be made to integrate the steam boiler and the recuperator into a housing so that as a result of firing the steam boiler the recuperator can also be held at operating temperature at the same time. Hot standby air from the first gas turbine can also be additionally used for this.

According to a further embodiment, the gas turbine power plant is run at a base load of about 50 MW-100 MW (pure steam turbine operation) and/or at a medium load of about 550 MW 600 MW (power plant in normal operation) and/or at a peak load of about 800 MW-850 MW (using the compressed-air storage vessel). Furthermore, the gas turbine power plant can be run in standby mode, without power output to the mains supply network.

A rapid power increase from the standby mode, as well as from the medium load operation to the peak load operation, for example, can be put into effect in this case by means of the compressed-air storage vessel. During this, the compressor section of the gas turbine installation can be ramped up slowly.

The previously given description of advantageous embodiments contain numerous features which are reproduced in the individual dependent claims, partially grouped to form pluralities of features. The person skilled in the art, however, expediently also considers these features individually and groups them to form practical further combinations. In particular, these features can be combined individually in each case and in any suitable combination with the provided gas turbine power plant and/or with the provided method for operating a gas turbine power plant of the respective independent claim.

### BRIEF DESCRIPTION OF THE DRAWINGS

Represented in the figures are exemplary embodiments, which are explained in more detail in the following.

In the drawing

FIG. 1 schematically shows a detail of a gas turbine power plant according to a first exemplary embodiment,

FIG. 2 schematically shows a detail of a gas turbine power plant with a recuperator according to a second exemplary embodiment,

FIG. 3 schematically shows a detail of a gas turbine power plant with a carbon dioxide separation plant according to a third exemplary embodiment,

FIG. 4 schematically shows a detail of a gas turbine power plant with a steam turbine installation according to a fourth exemplary embodiment,

FIG. 5 schematically shows a detail of a gas turbine power plant with a compressed-air storage vessel according to a fifth exemplary embodiment.

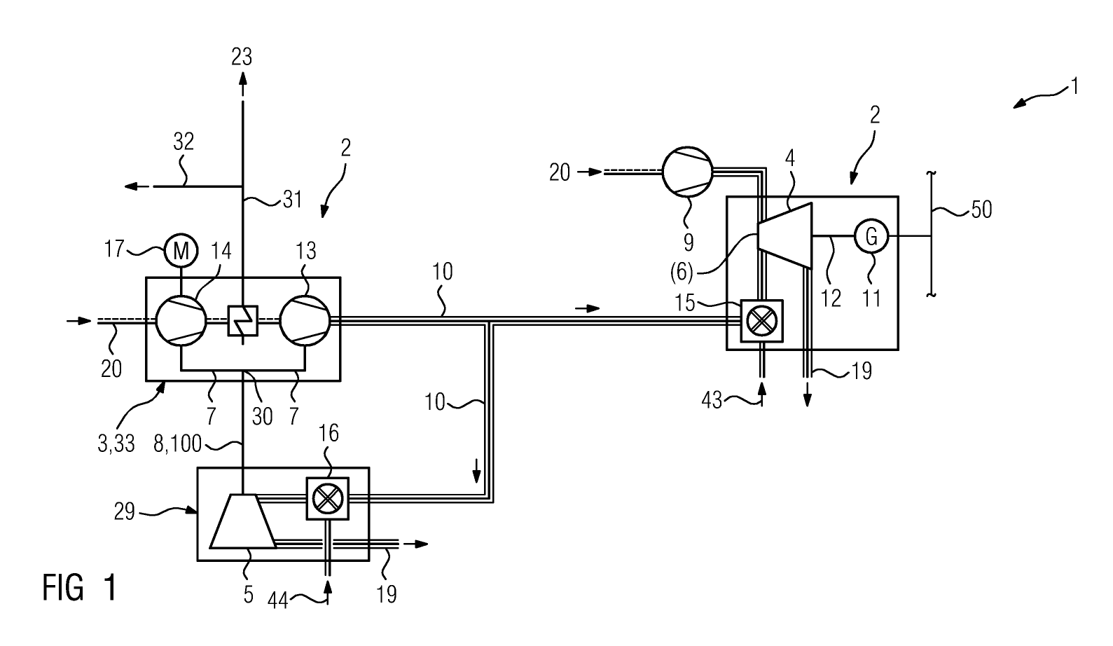

Exemplary embodiments: flexible gas turbine power plant in various modular development stages (FIGS. 1-5)

### DETAILED DESCRIPTION OF INVENTION

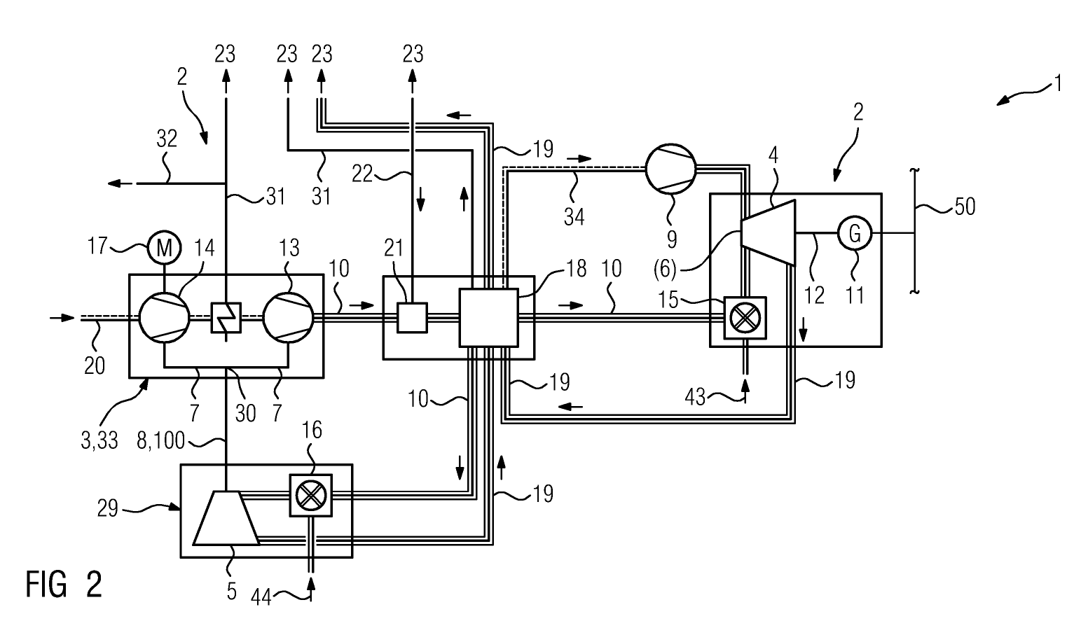

FIGS. 1-5 show various modular basic/development stages of a gas turbine power plant 1, where like designations in FIGS. 1-5 refer to the same components in each case. The basic/development stages in FIGS. 1-5, based on the basic development shown in FIG. 1, are attached to each other in a modular manner, wherein the individual development stages in FIGS. 2-5, however, can be directly realized alone (optionally combinable modules) as a development of the basic development according to FIG. 1.

Basic Development—Decoupled Gas Turbine Installation (FIG. 1)

FIG. 1 shows the gas turbine power plant 1 with a gas turbine installation 2 consisting of a compressor 3, a combustion chamber 15 with burners, a gas turbine 4 and a generator 11 for power generation, which is coupled to the gas turbine 4 via an engageable clutch 12.

This gas turbine installation 2, or the combustion chamber 15 with the burners, in this case is fired with natural gas fuel or coal-derived gas fuel 43.

As FIG. 1 also shows, deviating from known gas turbine installations, the compressor 3 and the gas turbine 4 are mechanically decoupled (6) here.

The driving of the compressor 3, with a compressor station 33 with two intercooled compressor sections 13 and 14, as FIG. 1 shows here, is effected by means of an additional gas turbine installation 29 with an additional, second gas turbine 5 and a natural gas fired 44 additional or second combustion chamber 116 with burners.

The compressor 3 of the gas turbine installation 2, driven by the second

gas turbine 5 which is coupled to the compressor 3, inducts fresh air 20 and compresses this to about 20 bar.

This compressed operating medium 10 of the compressor 3, i.e. the compressed air 10, i.e. the compressed compressor air, or just compressor air 10 for short, on the one hand is fed with the respective fuel to the combustion chamber 15 of the gas turbine installation 2 and, on the other hand, is fed with the respective fuel to the combustion chamber 16 of the additional or second gas turbine installation 29. In the combustion chamber 15 of the gas turbine installation 2, the mixture of compressed compressor air 10 and fuel is combusted.

The hot exhaust gases from the combustion, heated to about 1500° C. as a result of said combustion, then flow into the gas turbine 4 of the gas turbine installation 2, in which these give up some of their energy, as a result of expansion, as kinetic energy to the gas turbine 4.

By means of the generator 11, which is coupled to the gas turbine 4, the mechanical power is then converted into electric power which is fed as electric current into a mains supply network 50.

From the gas turbine exhaust, the exhaust gases or flue gases 19 are discharged either directly or sometimes also via a heat exchanger which preheats the fresh air.

In the combustion chamber 16 of the second gas turbine installation 29, the mixture of compressed compressor air 10 and fuel there is also combusted.

The hot exhaust gases, heated as a result of the combustion, then flow into the second gas turbine 5 of the second gas turbine installation 29 in which these also give up some of their energy, as a result of expansion, as kinetic energy to this second gas turbine 5.

Coupled to the second gas turbine 5, via a mechanical output-input shaft connection 30 or 8, 7, is the compressor 3 of the gas turbine installation 2 which is consequently driven by the second gas turbine, independently of the first gas turbine 4.

From the gas turbine exhaust of this second gas turbine 5, the exhaust gases or flue gases 19 are also discharged either directly or sometimes also via a heat exchanger which preheats the fresh air.

The decoupling of the compressor 3 of the gas turbine installation 2 from the actually associated first gas turbine 4 of this gas turbine installation 2 ensures that this compressor 3 can be run independently of the rotational speed of the first gas turbine 4.

Influences on the main supply network side, such as generating deficiencies in the mains supply network 50, which act upon the first gas turbine 4 as a result of speed reduction, are consequently not able to also have an impact upon the compressor 3, which is decoupled from the first gas turbine 4.

This gives the depicted gas turbine power plant 1 the capability to react flexibly and also rapidly to fluctuations in the mains supply network 50.

As FIG. 1 also shows, provision is made in the first gas turbine 4 for a blower 9 which supplies the first gas turbine 4 with air 20 or fresh air 20.

By means of this blower 9, and also a heat source which heats blower air 20, such as a (pilot) burner or a furnace (not shown), in standby mode of the gas turbine installation 2, i.e. with the gas turbine installation 2 yielding no electric power to the mains supply network 50 in this case, the gas turbine installation 2 or the first gas turbine 2 is held at operating temperature, or just below it.

To this end, the blower air 20 is directed through pilot burners (not shown) to the first gas turbine installation 2 and heats the air here to about 600° C.-700° C.

The hot air is allowed to circulate in the first gas turbine installation 2 with continuous separation of some of the exhaust gases 19 and supplementation with fresh air 20 supplied via the blower 9 in order to hold the oxygen content sufficiently high in order to hold the components of the first gas turbine installation at operating temperature, or just below it.

Alternatively, the exhaust gases 19 can also be completely extracted (not shown), wherein in this case it can be provided that these exhaust gases, by means of a heat exchanger, correspondingly heat the blower air 20 downstream of the blower 9 for the hot air flow through the first gas turbine installation 2.

As another alternative (not shown) for maintaining the operating temperature in standby mode of the first gas turbine installation 2, it can be provided that a separate air recirculation, with separate recirculating air 20 delivered by the blower 9, is realized and operates independently of the burner air. To this end, for example oil-operated or gas-operated furnaces are provided as a heat source and heat the blower air 20 to a correspondingly high level.

Since, therefore, all the components, especially the first gas turbine, are held at operating temperature in standby mode, it is possible to bring the gas turbine installation 2 very rapidly from standby mode to high power if high outputs are required within a short time, for example in the event of the renewable energy decreasing in the mains supply network 50 due to environmental conditions.

Such maintaining of the operating temperature in standby mode in the first gas turbine installation 2 can correspondingly also be provided for the second gas turbine installation 29 in standby mode there.

As FIG. 1 also shows, the gas turbine installation 2, in the compressor 3, provides an additional drive unit 17, in this case an E-motor 17, for driving the compressor 3.

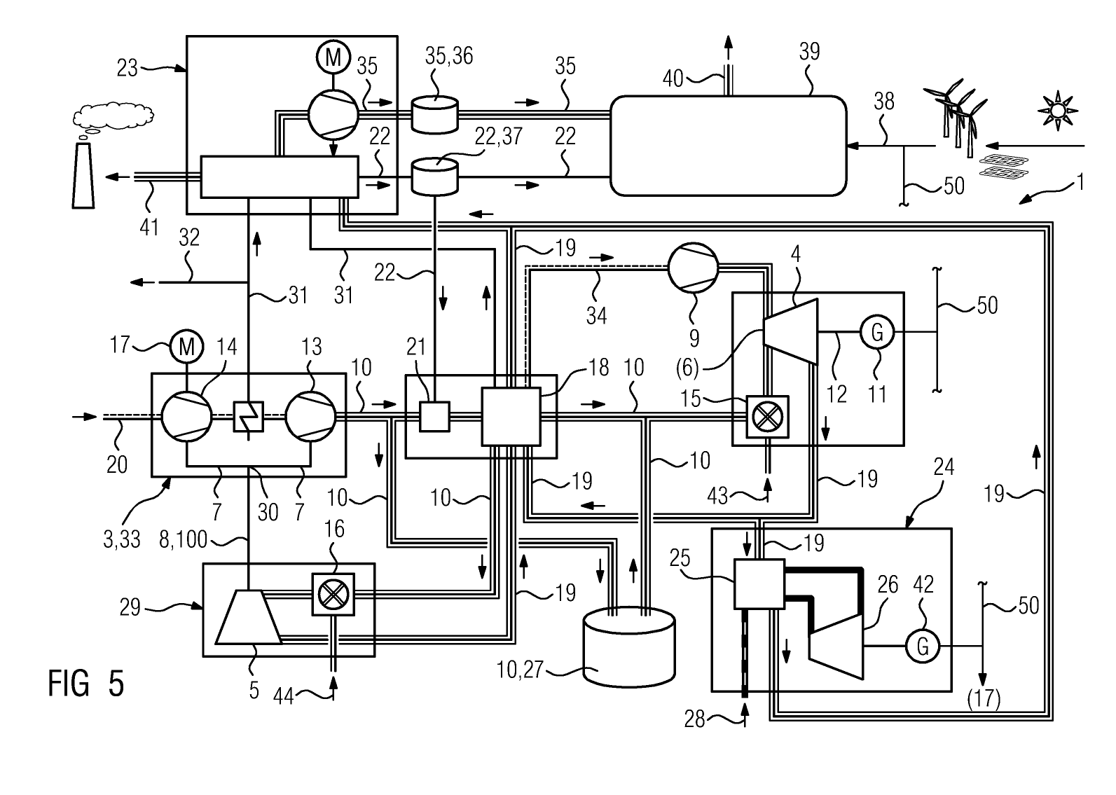

In this way, it is possible to operate the compressor 3 even when the first gas turbine installation 2 and/or the second gas turbine installation 29 is, or are, ramped down. The compressor air 10 from the compressor 3 which is compressed here can then be used for filling a compressed-air storage vessel 27 (cf. FIG. 5), for example, in order to be made available for a ramping up of the gas turbine installations 2, 29 in the event of a necessary rapid power increase.

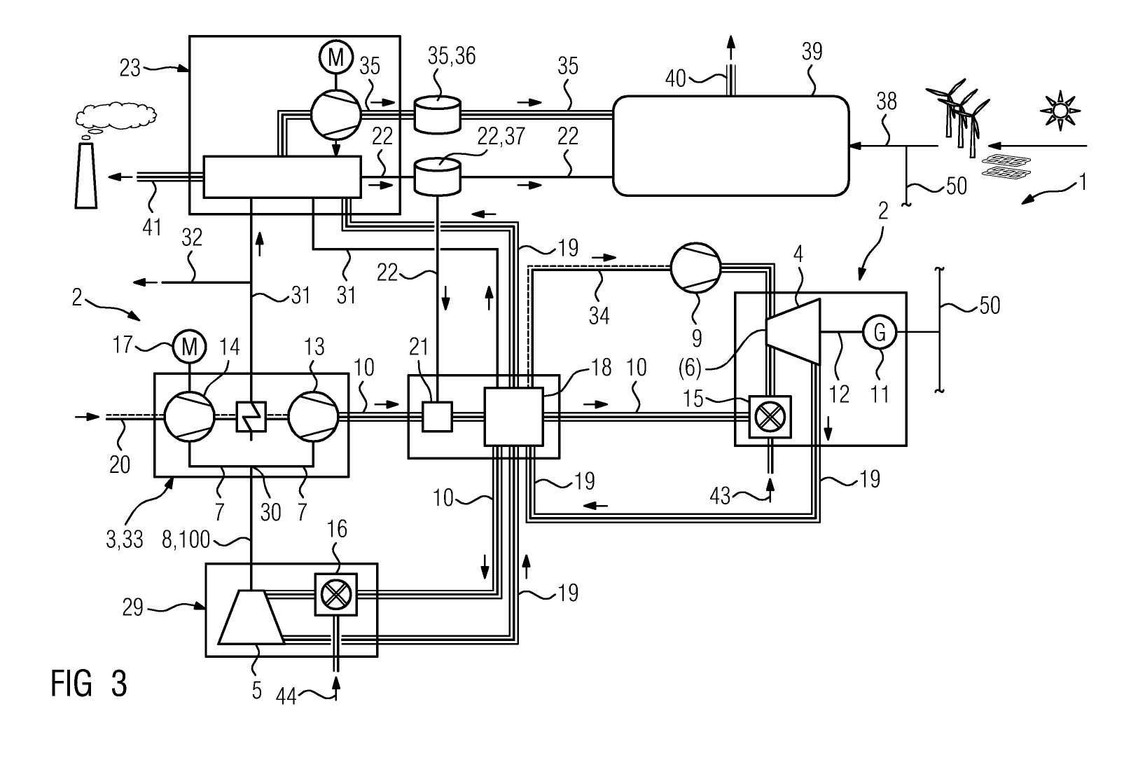

FIG. 1 also shows that waste heat 31 from the compressor station 33 is discharged and made available for waste heat utilization, for example for a carbon dioxide separation plant 23 (cf. FIGS. 3 5) or for district heating use 32.

Development Stage 1—Recuperator (FIG. 2)

As FIG. 2 shows, the gas turbine power plant 1 provides a recuperator 18 in this development stage.

On one side, the compressed operating medium issuing from the compressor 3 or the compressor station 33, or the compressed compressor air 10, is directed through this recuperator 18. On the other side, for the exchange of heat in the recuperator 18, the exhaust gases 19 flow from the first gas turbine 4 and from the second gas turbine 5 through the recuperator 18.

In the recuperator 18, the exchange of heat takes place between the exhaust gases 19 of the two gas turbines 4 and 5 and the compressor air 10, wherein the exhaust gases 19 give up some of their heat/energy to the compressor air 10 and consequently heat this, for example from about 200° C. to about 600° C.

As FIG. 2 also shows, the residual heat 31 of the exhaust gases 19, for example at temperatures in the region of about 600° C., is put to further use after the exchange of heat in the recuperator 18.

So, as indicated in FIG. 2, the exhaust gases 19, downstream of the recuperator 18, are fed to the carbon dioxide separation plant 23 where, by utilizing their residual heat 31, carbon dioxide is separated out from these exhaust gases 19.

FIG. 2 furthermore shows that this development stage provides a saturation device 21, integrated into the recuperator 18, by means of which the compressor air 10 is saturated with water 22 before the exchange of heat in the recuperator 18. This water 22, as FIG. 2 indicates (cf. also FIGS. 3-5), as a product created during the carbon dioxide separation 23, is fed from there to the saturation device 21.

It is also provided, in this development stage according to FIG. 2, to hold the first gas turbine installation 2 at operating temperature. To this end, air 34 from the recuperator 18 is fed to the blower 9 which blows this air—again heated to a high temperature by means of the heat source, for example a burner or furnace (not shown)—into the first gas turbine installation 2.

Development Stage 2—Carbon Dioxide Separation and Storage of Renewable Energy (FIG. 3)

FIG. 3 shows the gas turbine installation 2 in a development stage which provides a carbon dioxide separation plant 23 for the exhaust gases 19 of the first and the second gas turbine installation 2, 29, or the first and the second gas turbine 4, 5, with simultaneous utilization of the waste heat 31 from the gas turbine power plant 1.

Thus, as FIG. 3 shows, the exhaust gases 19 of the first and the second gas turbine 4, 5 are forwarded to the carbon dioxide separation plant 23.

In this case, with simultaneous utilization of the waste heat 31 from the compressor station 33 as well as the waste heat 31 from the exhaust gases 19 of the first and the second gas turbine 4, 5, the carbon dioxide 35 is separated out from the exhaust gases 19 and temporarily stored in a temporary storage facility 36 or in a larger pipeline system 36. The now scrubbed residual gas/exhaust gas 41 is discharged to the environment.

The water 22 which is used for the saturation of the compressor air 10 also accumulates here (cf. FIG. 2) and, as FIG. 3 shows, is temporarily stored in the carbon dioxide separation plant in an additional temporary storage facility 37.

As FIG. 3 also shows, the temporarily stored carbon dioxide 35 and the temporarily stored water 22 are then used for a storage 39 of (surplus) renewable energy 38 in the form of methane/methanol.

In this renewable energy storage facility 38, the water 22, by means of the renewable energy 38, is split by means of electrolysis into hydrogen and oxygen 40.

Whereas the oxygen 40 is supplied for further use, the hydrogen, together with the carbon dioxide 35, is used for a methane/methanol synthesis for producing the methane/methanol.

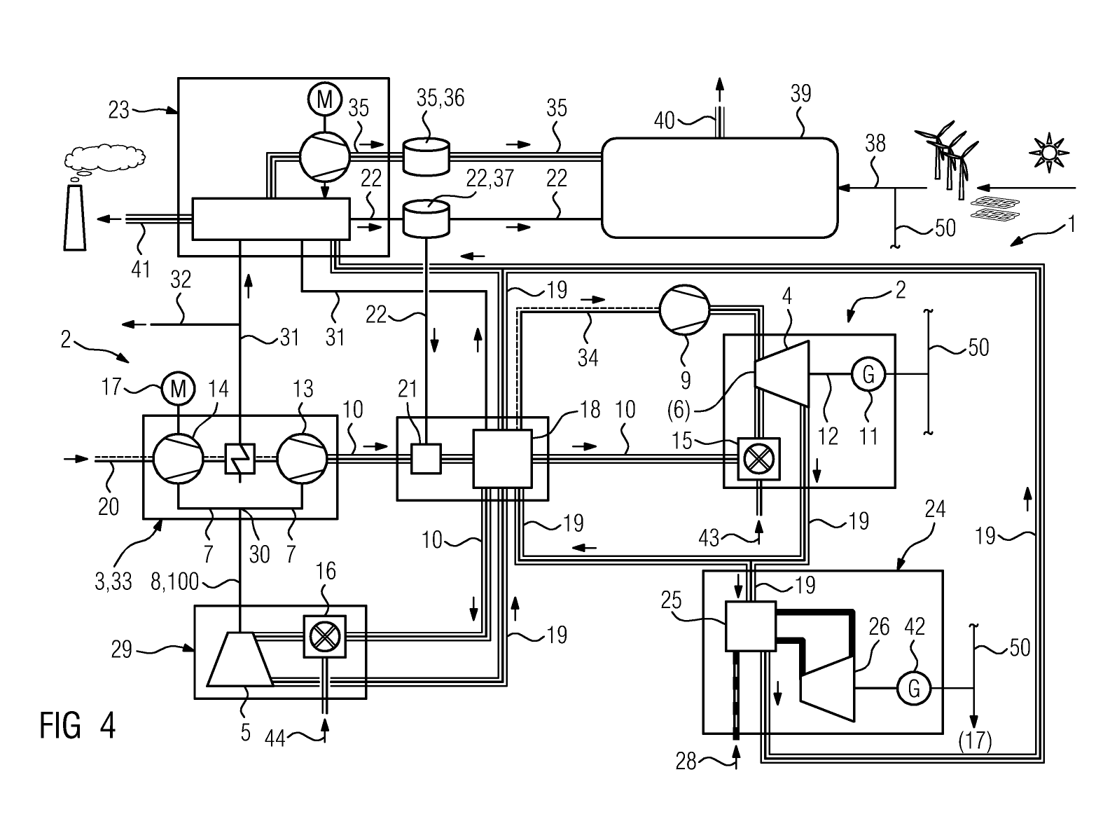

Development Stage 3—Steam Turbine Installation (FIG. 4)

Development stage 3, as FIG. 4 shows, provides a steam turbine installation 24 as an additional, extending module.

This steam turbine installation 24 according to a conventional construction—provides a steam boiler 25, a steam turbine 26 and also a generator 42 which generates electricity.

The steam turbine 25 of the steam turbine installation 24 can be heated by means of an engageable coal-fired plant 28. At the same time, the steam boiler 25 is supplied with some of the exhaust gases 19, for example 5-25%, from the first gas turbine 4.

The remainder of the exhaust gases 19, for example about 95%-75%, from the first gas turbine 4, as described (cf. FIGS. 2 and 3), is fed to the carbon dioxide separation plant 23 via the recuperator 18.

The exhaust gases 19 of the steam turbine installation 24 or of the steam turbine 26 (saturated steam), as FIG. 4 shows, are fed to the carbon dioxide separation plant 23. At times during which the gas turbines 4, 5 are ramped down, the carbon dioxide separation plant 23 is dispensed with, or this is then supplied with some of a low-pressure steam from the compressor station 33.

The steam turbine installation 24, possibly under partial load, is run continuously and not ramped up and ramped down depending upon requirement like the first gas turbine 4 and the second gas turbine 5 (cf. standby mode).

At times during which the gas turbine 4 is ramped down or the first gas turbine installation 2 is, or runs, in standby mode, the power requirement in the mains supply network 50 can be met in this case principally from wind power/solar power and the steam turbine installation 24 or the steam turbine 26, being operated by means of the engageable coal-fired plant 28, drives the generator 42 with correspondingly low output.

The generated power of the generator on the one hand is fed into the mains supply network 50 in order to be temporarily stored there, or to be made available from there, for example via the operation of pumped-storage power stations or the described methane/methanol synthesis.

On the other hand, the generated power of the generator in this phase is used for the (indirect) driving of the compressor station 33 or its E-motor 17 (alternatively, a direct driving of the compressor station via a mechanical coupling of the steam turbine 26 to the compressor 3 is also possible here, but not shown) in order to provide compressor air 10 from there, as described, for a compressed-air storage vessel 27 (cf. FIG. 5), for example, during these periods.

The first and the second gas turbine 4, 5 are held in operational readiness during this phase with minimum fuel (without load). As a result of the described decoupling of turbine section 4 and compressor section 3 (cf. basic development, FIG. 1) the fuel consumption is minimal.

If, within a very short time, high outputs of the gas turbine power plant 1 are required/necessitated, e.g. in the event of the solar energy and/or wind energy decreasing, the gas turbine installation 2, by means of the compressed air supplied to it, i.e. the compressed compressor air 10 supplied to it, can be rapidly brought up to power since, moreover, as FIG. 4 also shows, the blower 19 holds the gas turbine installation 2 at operating temperature in the described manner (cf. development stage 1, FIG. 2),

The gas turbines 4 and 5, as well as the steam turbine 26, can be ramped upon moderately slowly during this, with consideration for components.

If, during the operating phase with high output, the additional coal-fired. plant 28 is disengaged, then the gas turbine power plant 1 is run with high efficiency,

It is also possible to accommodate the steam boiler 25 of the steam turbine installation 24 and the recuperator 18 in a housing (not shown), so that as a result of the firing of the steam turbine installation 24 the recuperator 18 can also be held at operating temperature. The hot standby air from the first gas turbine 4 can also be used for this purpose.

Development Stage 4—Compressed-Air Storage Vessel (FIG. 5)

According to the development stage represented in FIG. 5, the gas turbine power plant 1 provides a compressed-air storage vessel 27.

This compressed-air storage vessel 27 is connected on one side to the compressor station 33 and connected on the other side to the first gas turbine installation 2, as a result of which the compressed-air storage vessel 27 is filled with compressor air 10 and the first gas turbine installation 2 can also be supplied with the compressor air 10 from the (filled) compressed-air storage vessel 27.

The filling of the compressed-air storage vessel 27 is carried out at times during which the gas turbine 4 is ramped down or the first gas turbine installation 2 or the second gas turbine installation 29 is running or is in standby mode.

In this case, as described (cf. development stage 3, FIG. 4), the steam turbine installation 24 or the steam turbine 26, operated by means of the engageable coal-fired plant 28, then drives the generator 42 with correspondingly low output, the output of which is used for driving the compressor station 33 or its E-motor 17.

The compressor air 10 from the compressor 3 is fed to the compressed-air storage vessel 27 and is stored there, at 20 bar, for example.

The compressed air, or compressor air 10, which is stored there, as described (cf. development stage 3, FIG. 4), is then made available in order to bring the gas turbine installation 4 very rapidly up to power when high outputs of the gas turbine power plant 1 are required/necessitated within a very short time, e.g. in the event of solar energy and/or wind energy decreasing.

The gas turbines 4 and 5 can be ramped up moderately slowly during this, with consideration for components.

In this case, the compressed-air storage vessel 27 is designed here in such a way that it can supply the first gas turbine 4 with compressed air 10 for about 20 min.

This time span is sufficient to ramp up especially the second gas turbine installation 29 and also the steam turbine installation 24 sufficiently slowly.

If the compressed-air storage vessel 27 is discharged, as described, then it can be replenished by means of carbon dioxide (not shown). In this case, this carbon dioxide can be fed via a carbon dioxide system to the compressed-air storage vessel 27.

Since the carbon dioxide is made available at higher pressures there, for example at 80 bar, than are provided for the compressed-air storage vessel 27, the carbon dioxide which is to be replenished is expanded from 80 bar to 20 bar, for example. In so doing, the carbon dioxide for replenishment cools down.

This cooled-down carbon dioxide or its coldness can additionally be used (not shown) to cool down a water flow in a condenser of the gas turbine power plant 1 to such a degree that a condenser pressure can be lowered still further.

If the compressed-air storage vessel 27 is not operated at constant pressure (not explained) but at increased pressure, a pressure reduction is necessary downstream of the compressed-air storage vessel 27 and upstream of the combustion chamber 15. This can be realized (not shown) by means of a throttling element or even by means of an expansion turbine.

Carbon dioxide from the compressed-air storage vessel 27 can also be extracted and further compressed (not shown), for example to 80 bar-120 bar, and then fed into a carbon dioxide system.

During phases in which renewable energy is to be fed into the mains supply network 50 as a priority, the gas turbine power plant 1, designed for a peak load output of about 600 MW, for example, can now be ramped down to 20 MW (in simple steam turbine mode). In this case, with very low fuel consumption and gas turbine installations 2 and 29 held in operational readiness or at operating temperature, the two gas turbine installations 2 and 29 now run in standby mode, whereas the steam turbine installation 24 is run with coal firing with moderate output. During this, the compressed-air storage vessel 27 is filled by means of the compressor 3, which is driven by means of the steam turbine installation 24.

If now on the network side—in the event of the renewable proportion decreasing or other frequency drops in the mains supply network 50 —high output is required from the gas turbine power plant 1, then the gas turbine power plant 1 can be ramped up to peak power within the shortest possible time, about 5-10 min., on account of being in operational readiness/at operating temperature. To this end, the compressed-air storage vessel 27 is emptied when feeding the compressed air 10 into the first gas turbine 4, while the operationally-ready gas turbine installations 4 and 29 are ramped up in parallel.

If the gas turbine installations 4 and 29 are ramped up, the compressed air supply from the compressed-air storage vessel 27 can be cut back. This is refilled in the net standby mode, as described.

if carbon dioxide separation 23 is carried out, or has to be carried out, as a state requirement for example, the gas turbine power plant 1 proves to be exceptionally efficient since the quantities of heat 31 for the carbon dioxide separation plant 23 (carbon dioxide—desorption process there) are met completely from waste energy of the gas turbine power plant 1 under optimum mode of operation, as described.

The gas turbine power plant 1 is also more favorable with regard to fuel costs—in comparison to a CCPP (combined cycle power plant)—since some of the fuel is introduced in the form of coal in this case.

We claim:

1. A gas turbine power plant, comprising:
a gas turbine installation, comprising:
a compressor,
a first gas turbine, and
a second gas turbine,
wherein the compressor and the first gas turbine are decoupled from each other, and
wherein the compressor is drive by using the second turbine.

2. The gas turbine power plant as claimed in claim 1, wherein a blower, which is coupled to the first gas turbine, and also a heat source for heating blower air, by use of which the first gas turbine is supplied with heated blower air.

3. The gas turbine power plant as claimed in claim 2, wherein the first gas turbine is supplied with heated blower air in a standby mode of the first gas turbine.

4. The gas turbine power plant as claimed in claim 1, wherein a recuperator which on one side is exposed to a throughflow of a gas which is compressed by the compressor, and on the other side is exposed to a throughflow of exhaust gas from the first gas turbine and from the second gas turbine for the exchange of heat between the compressed gas from the compressor and the exhaust gas from the first gas turbine and from the second gas turbine.

5. The gas turbine power plant as claimed in claim 1, wherein a recuperator which on one side is exposed to a throughflow of a gas which is compressed by the compressor, and on the other side is exposed to a throughflow of exhaust gas from the first gas turbine or from the second gas turbine for the exchange of heat between the compressed gas from the compressor and the exhaust gas from the first gas turbine or from the second gas turbine.

6. The gas turbine power plant as claimed in claim 1, wherein a saturation device, by use of which gas which is compressed by the compressor of the gas turbine installation is saturated with water.

7. The gas turbine power plant as claimed in claim 6, wherein the compressed gas of the compressor originates upstream of the exchange of heat in the recuperator.

8. The gas turbine power plant as claimed in claim 1, further comprising a carbon dioxide separation plant which is supplied with waste heat from the gas turbine power plant, to which exhaust gas from the first gas turbine or exhaust gas from the second turbine is fed for carbon dioxide separation.

9. The gas turbine power plant as claimed in claim 1, further comprising a carbon dioxide separation plant which is supplied with waste heat from the gas turbine power plant, to which exhaust gas from the first gas turbine and exhaust gas from the second turbine is fed for carbon dioxide separation.

10. The gas turbine power plant as claimed in claim 1, further comprising a steam turbine installation, coupled to the first gas turbine, which includes a steam boiler and a steam turbine, to which steam boiler exhaust gas from the first gas turbine is fed.

11. The gas turbine power plant as claimed in claim 10, wherein the steam turbine installation which is coupled to the first gas turbine has an engageable coal-fired, gas-fired and/or diesel oil-fired plant.

12. The gas turbine power plant as claimed in claim 10, wherein the power plant is operated such that the steam turbine installation is run continuously and the steam turbine installation is fired with coal, gas or diesel oil in a standby mode of the gas turbine installation, and delivers output for filling a compressed-air storage vessel in the standby mode of the gas turbine installation and supplies an electric drive unit of the compressor with electric power in the standby mode of the gas turbine installation.

13. The gas turbine power plant as claimed in claim 10, wherein the power plant is operated such that the steam turbine installation is run continuously or that the steam turbine installation is fired with coal, gas or diesel oil in a standby mode of the gas turbine installation, and delivers output for filling a compressed-air storage vessel in the standby mode of the gas turbine installation or supplies an electric drive unit of the compressor with electric power in the standby mode of the gas turbine installation.

14. The gas turbine power plant as claimed in claim 13,
wherein the compressed-air storage vessel which is filled with a gas which is compressed by means of the compressor, and
wherein the compressed gas is stored in the compressed-air storage as compressed air and the stored compressed air from the compressed-air storage vessel is fed to the first gas turbine.

15. The gas turbine power plant as claimed in claim 13,
wherein the compressed-air storage vessel which is filled with a gas which is compressed by means of the compressor, and
wherein the compressed gas is stored in the compressed-air storage as compressed air or the stored compressed air from the compressed-air storage vessel is fed to the first gas turbine.

16. The gas turbine power plant as claimed in claim 14, wherein the gas turbine plant is operated such that for a rapid power increase of the gas turbine power plant the compressed air from the compressed-air storage vessel is fed to the first gas turbine.

17. The gas turbine power plant as claimed in claim 1, wherein the gas turbine power plant is operated such that waste heat from the gas turbine power plant is used for carbon dioxide separation, for district heating, for seawater desalination, for brown coal drying, and/or for operating a refrigerating machine.

18. A method for operating a gas turbine power plant,
providing a gas turbine installation including a compressor, a first gas turbine, and a second turbine: and
operating the compressor of the gas turbine installation using the second turbine,
wherein the compressor of the gas turbine installation and the first gas turbine of the gas turbine installation are decoupled from each other.
